(19) United States
(12) Patent Application Publication
(10) Pub. No.: US 2020/0007999 A1
(43) Pub. Date: Jan. 2, 2020

(54) ELECTRONIC DEVICE

(71) Applicant: QISDA CORPORATION, Taoyuan City (TW)

(72) Inventor: Chih-Ming Lin, New Taipei City (TW)

(21) Appl. No.: 16/411,060

(22) Filed: May 13, 2019

(30) Foreign Application Priority Data
Jun. 28, 2018 (CN) 201810691943.1

(51) Int. Cl. H04R 29/00; H04R 1/02; G09G 5/00; H04R 1/34

(52) U.S. Cl. CPC H04R 29/001; H04R 1/028; H04R 1/025; H04R 2430/01; H04R 1/345; H04R 2499/15; H04R 2201/025; G09G 5/003

(57) ABSTRACT

An electronic device includes a main body, a rotating member, a hinge, a speaker and a controller. The rotating member is pivotally connected to a side of the main body by the hinge. The hinge includes an angle sensor. The angle sensor senses an angle included between the rotating member and the main body. The speaker is selectively disposed in one of the main body and the rotating member. The controller is electrically connected to the speaker and the angle sensor. The controller adjusts a volume of the speaker according to the angle. Furthermore, the main body may include a display module electrically connected to the controller. The controller adjusts a display function of the display module according to the angle.

### BACKGROUND OF THE INVENTION

### 1. Field of the Invention

The invention relates to an electronic device and, more particularly, to an electronic device capable of adjusting a volume and/or a display function according to an angle included between a rotating member and a main body.

### 2. Description of the Prior Art

At present, various electronic devices are equipped with a speaker and a display module for generating sound and display images. In general, the prior art utilizes a button, a knob or a touch panel to adjust a volume of a speaker and adjust a display function of a display module. However, the aforesaid adjusting manner is monotonous and uncreative for a user who is always seeking for new matters, such that it cannot excite the user to purchase the electronic device.

### SUMMARY OF THE INVENTION

An objective of the invention is to provide an electronic device capable of adjusting a volume and/or a display function according to an angle included between a rotating member and a main body, so as to solve the aforesaid problem.

According to an embodiment of the invention, an electronic device comprises a main body, a rotating member, a hinge, a speaker and a controller. The rotating member is pivotally connected to a side of the main body by the hinge. The hinge comprises an angle sensor. The angle sensor senses an angle included between the rotating member and the main body. The speaker is selectively disposed in one of the main body and the rotating member. The controller is electrically connected to the speaker and the angle sensor. The controller adjusts a volume of the speaker according to the angle.

According to another embodiment of the invention, an electronic device comprises a main body, a rotating member, a hinge and a controller. The main body comprises a display module. The rotating member is pivotally connected to a side of the main body by the hinge. The hinge comprises an angle sensor. The angle sensor senses an angle included between the rotating member and the main body. The controller is electrically connected to the display module and the angle sensor. The controller adjusts a display function of the display module according to the angle.

As mentioned in the above, the invention uses the hinge to pivotally connect the rotating member to a side of the main body and disposes the angle sensor at the hinge. When a user rotates the rotating member, the angle sensor senses the angle included between the rotating member and the main body, such that the controller adjusts the volume of the speaker and/or the display function of the display module according to the angle included between the rotating member and the main body. In other words, the user can adjust the volume and/or the display function by rotating the rotating member. Compared to the adjusting manner of the prior art using the button, the knob or the touch panel, the invention can provide creative and innovative operation experience for the user, so as to excite the user to purchase the electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view illustrating an electronic device according to an embodiment of the invention.

FIG. 2 is a functional block diagram illustrating the electronic device shown in FIG. 1.

FIG. 3 is a schematic view illustrating the rotating member shown in FIG. 1 after rotating with respect to the main body.

FIG. 4 is a schematic view illustrating an electronic device according to another embodiment of the invention.

FIG. 5 is a schematic view illustrating an electronic device according to another embodiment of the invention.

FIG. 6 is a functional block diagram illustrating the electronic device shown in FIG. 5.

FIG. 7 is a schematic view illustrating the rotating member shown in FIG. 5 after rotating with respect to the main body.

FIG. 8 is a schematic view illustrating an electronic device according to another embodiment of the invention.

FIG. 9 is a schematic view illustrating an electronic device according to another embodiment of the invention.

FIG. 10 is a functional block diagram illustrating the electronic device shown in FIG. 9.

### DETAILED DESCRIPTION

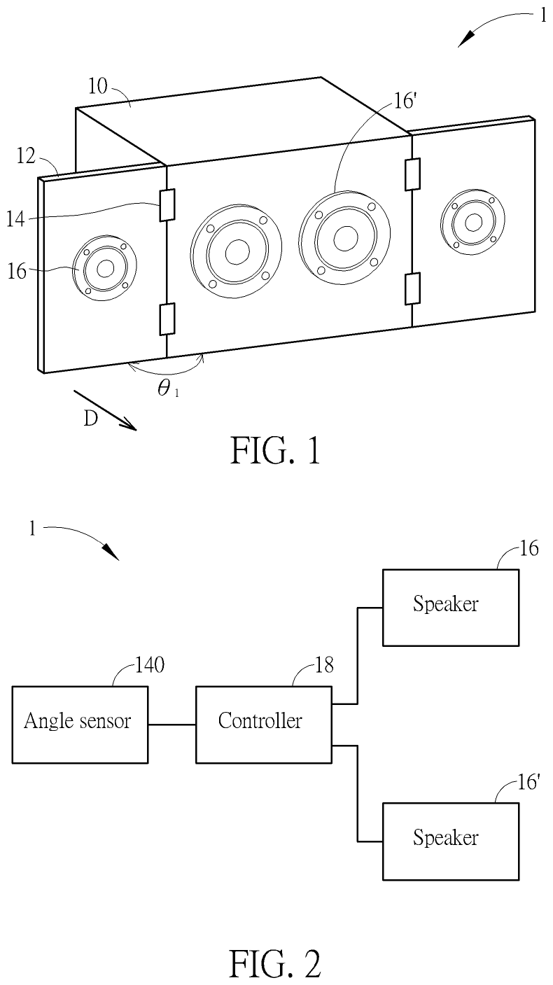

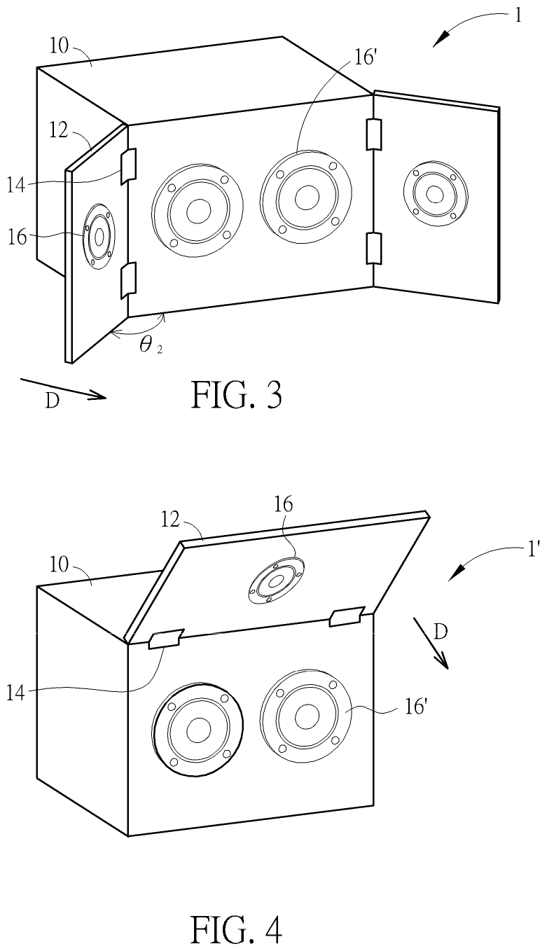

Referring to FIGS. 1 to 3, FIG. 1 is a schematic view illustrating an electronic device 1 according to an embodiment of the invention, FIG. 2 is a functional block diagram illustrating the electronic device 1 shown in FIG. 1, and FIG. 3 is a schematic view illustrating the rotating member 12 shown in FIG. 1 after rotating with respect to the main body 10.

As shown in FIGS. 1 and 2, the electronic device 1 comprises a main body 10, a rotating member 12, a hinge 14, a speaker 16 and a controller 18. The rotating member 12 is pivotally connected to a side of the main body 10 by the hinge 14 and the hinge 14 comprises an angle sensor 140. In this embodiment, the rotating member 12 may be pivotally connected to a side of the main body 10 by a plurality of hinges 14 and the angle sensor 140 may be disposed at one of the hinges 14. The angle sensor 140 is configured to sense an angle included between the rotating member 12 and the main body 10. In this embodiment, the angle sensor 140 may be a resistance sensor, an electronic sensor, a motor, and so on according to practical applications. Furthermore, the invention may use the hinges 14 to pivotally connect one single rotating member 12 to a side of the main body 10 or use the hinges 14 to pivotally connect a plurality of rotating members 12 to a plurality of sides of the main body 10. As shown in FIGS. 1 and 3, two rotating members 12 are pivotally connected to opposite sides of the main body 10, respectively, but are not so limited.

The speaker 16 is selectively disposed in one of the main body 10 and the rotating member 12. In this embodiment, the speaker 16 is disposed in the rotating member 12. In another embodiment, the speaker 16 may be disposed in the main body 10. Furthermore, the invention may dispose the speaker 16 in the rotating member 12 and dispose another speaker 16′ in the main body 10. The controller 18 is electrically connected to the speakers 16, 16′ and the angle sensor 140. In practical applications, the controller 18 may be disposed in the main body 10 or the rotating member 12. When the angle sensor 140 senses the angle included between the rotating member 12 and the main body 10, the controller 18 may adjust a volume of the speakers 16, 16′ according to the angle included between the rotating member 12 and the main body 10.

As shown in FIG. 1, when the angle sensor 140 senses the angle θ1 included between the rotating member 12 and the main body 10, the controller 18 may adjust the volume of the speakers 16, 16′ according to the angle θ1 included between the rotating member 12 and the main body 10 to be another volume corresponding to the angle θ1. As shown in FIG. 3, when the angle sensor 140 senses the angle θ2 included between the rotating member 12 and the main body 10, the controller 18 may adjust the volume of the speakers 16, 16′ according to the angle θ2 included between the rotating member 12 and the main body 10 to be another volume corresponding to the angle θ2. In this embodiment, the invention may establish an angle/volume loot-up table in advance, so as to look a specific angle up in the angle/volume loot-up table to obtain a volume correspondingly. Furthermore, the invention may establish an angle/volume conversion algorithm in advance, so as to calculate a volume according to a specific angle correspondingly.

In this embodiment, when the angle included between the rotating member 12 and the main body 10 is larger (as the angle θ1 shown in FIG. 1), the controller 18 may increase the volume of the speakers 16, 16′; and when the angle included between the rotating member 12 and the main body 10 is smaller (as the angle θ2 shown in FIG. 3), the controller 18 may decrease the volume of the speakers 16, 16′. However, the invention is not limited to the aforesaid embodiment. Accordingly, a user can adjust the volume of the speakers 16, 16′ by rotating the rotating member 12. Furthermore, since the speaker 16 is disposed in the rotating member 12, a sound direction D of the speaker 16 will change along with a rotation of the rotating member 12, as shown in FIGS. 1 and 3. Accordingly, when the user is located at a specific position with respect to the electronic device 1, the user may rotate the rotating member 12 to orientate the sound direction D of the speaker 16 to himself/herself, such that the user may receive the sound sent out by the speaker 16 more clearly.

Referring to FIG. 4, FIG. 4 is a schematic view illustrating an electronic device 1′ according to another embodiment of the invention. The main difference between the electronic device 1′ and the electronic device is that the electronic device 1′ uses the hinges 14 to pivotally connect one single rotating member 12 to a side of the main body 10 (e.g. a top side shown in FIG. 4), but is not so limited.

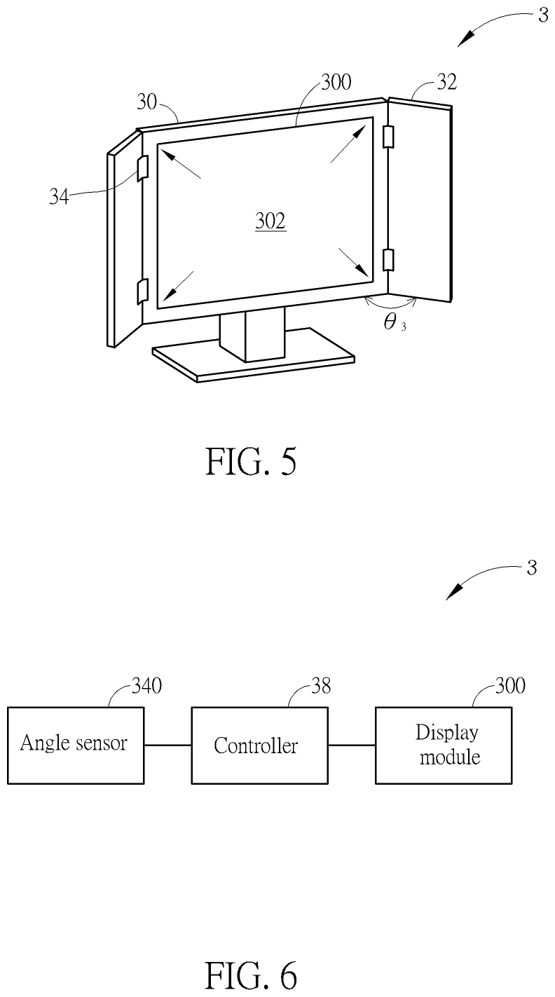

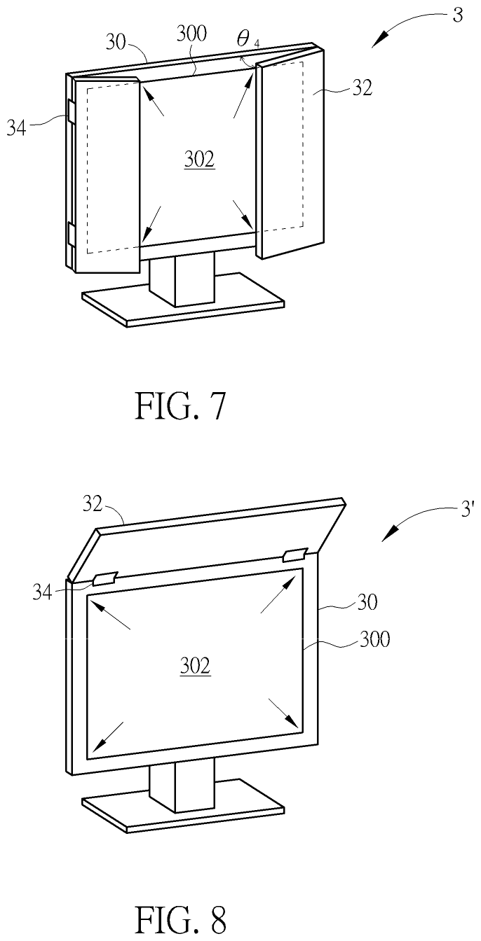

Referring to FIGS. 5 to 7, FIG. 5 is a schematic view illustrating an electronic device 3 according to another embodiment of the invention, FIG. 6 is a functional block diagram illustrating the electronic device 3 shown in FIG. 5, and FIG. 7 is a schematic view illustrating the rotating member 32 shown in FIG. 5 after rotating with respect to the main body 30.

As shown in FIGS. 5 and 6, the electronic device 3 comprises a main body 30, a rotating member 32, a hinge 34 and a speaker 38. The main body 30 comprises a display module 300, wherein the display module 300 may be a liquid crystal display module, a plasma display module, an organic light emitting diode display module or other display modules according to practical applications. The rotating member 32 is pivotally connected to a side of the main body 30 by the hinge 34 and the hinge 34 comprises an angle sensor 340. In this embodiment, the rotating member 32 may be pivotally connected to a side of the main body 30 by a plurality of hinges 34 and the angle sensor 340 may be disposed at one of the hinges 34. The angle sensor 340 is configured to sense an angle included between the rotating member 32 and the main body 30. In this embodiment, the angle sensor 340 may be a resistance sensor, an electronic sensor, a motor, and so on according to practical applications. Furthermore, the invention may use the hinges 34 to pivotally connect one single rotating member 32 to a side of the main body 30 or use the hinges 34 to pivotally connect a plurality of rotating members 32 to a plurality of sides of the main body 30. As shown in FIGS. 5 and 7, two rotating members 32 are pivotally connected to opposite sides of the main body 30, respectively, but are not so limited.

The controller 38 is electrically connected to the display module 300 and the angle sensor 340. In practical applications, the controller 38 may be disposed in the main body 30 or the rotating member 32. When the angle sensor 340 senses the angle included between the rotating member 32 and the main body 30, the controller 38 may adjust a display function of the display module 300 according to the angle included between the rotating member 32 and the main body 30. In this embodiment, the aforesaid display function may comprise at least one of a display range, a display brightness and a display mode.

The adjustment of the display range is exemplified in the following. As shown in FIG. 5, when the angle sensor 340 senses the angle θ3 included between the rotating member 32 and the main body 30, the controller 38 may adjust the display range 302 of the display module 300 according to the angle θ3 included between the rotating member 32 and the main body 30 to be another display range corresponding to the angle θ3. As shown in FIG. 7, when the angle sensor 340 senses the angle θ4 included between the rotating member 32 and the main body 30, the controller 38 may adjust the display range 302 of the display module 300 according to the angle θ4 included between the rotating member 32 and the main body 30 to be another display range corresponding to the angle θ4. In this embodiment, the invention may establish an angle/display range loot-up table in advance, so as to look a specific angle up in the angle/display range loot-up table to obtain a display range correspondingly. Furthermore, the invention may establish an angle/display range conversion algorithm in advance, so as to calculate a display range according to a specific angle correspondingly.

In this embodiment, when the angle included between the rotating member 32 and the main body 30 is larger (as the angle θ3 shown in FIG. 5), the controller 38 may increase the display range 302 of the display module 300; and when the angle included between the rotating member 32 and the main body 30 is smaller (as the angle θ4 shown in FIG. 7), the controller 38 may decrease the display range 302 of the display module 300. However, the invention is not limited to the aforesaid embodiment. Accordingly, a user can adjust the display range of the display module 300 by rotating the rotating member 32. Furthermore, the aforesaid display range represents a visible area provided by the display module 300 for the user. Therefore, no matter where the rotating member 32 rotates to with respect to the main body 30, the visible area provided by the display module 300 for the user will never be blocked by the rotating member 32.

When the display function comprises the display brightness, the invention may also adjust the display brightness by the aforesaid manner of adjusting the display range. For example, when the angle included between the rotating member 32 and the main body 30 is larger (as the angle θ3 shown in FIG. 5), the controller 38 may increase the display brightness of the display module 300; and when the angle included between the rotating member 32 and the main body 30 is smaller (as the angle θ4 shown in FIG. 7), the controller 38 may decrease the display brightness of the display module 300. However, the invention is not limited to the aforesaid embodiment.

When the display function comprises the display mode, the invention may preset different angles for different display modes (e.g. singing mode, theater mode, etc.) correspondingly. When the user rotates the rotating member 32 with respect to the main body 30 to a specific angle, the controller 38 may adjust the display mode of the display module 300 to be a specific display mode correspondingly.

Referring to FIG. 8, FIG. 8 is a schematic view illustrating an electronic device 3′ according to another embodiment of the invention. The main difference between the electronic device 3′ and the aforesaid electronic device 3 is that the electronic device 3′ uses the hinges 34 to pivotally connect one single rotating member 32 to a side of the main body 30 (e.g. a top side shown in FIG. 8), but is not so limited.

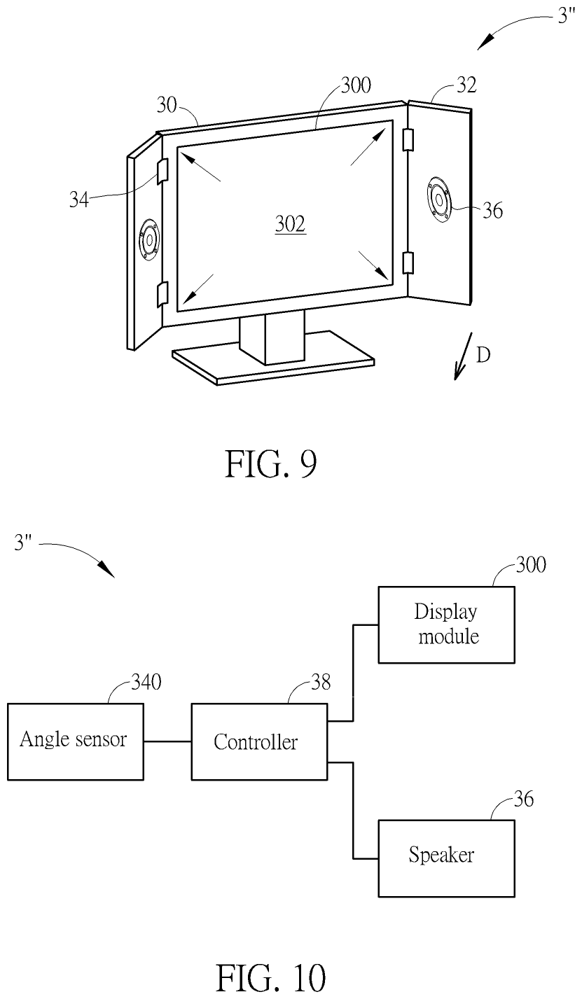

Referring to FIGS. 9 and 10, FIG. 9 is a schematic view illustrating an electronic device 3″ according to another embodiment of the invention and FIG. 10 is a functional block diagram illustrating the electronic device 3′ shown in FIG. 9. The main difference between the electronic device 3″ and the aforesaid electronic device 3 is that the electronic device 3″ further comprises a speaker 36, as shown in FIGS. 9 and 10. In this embodiment, the speaker 36 is disposed in the rotating member 32. In another embodiment, the speaker 36 may be disposed in the main body 30. In other words, the speaker 36 may selectively disposed in one of the main body 30 and the rotating member 32. The controller 38 is electrically connected to the speaker 36. Accordingly, when the angle sensor 340 senses the angle included between the rotating member 32 and the main body 30, the controller 38 may adjust a volume of the speakers 36 according to the angle included between the rotating member 32 and the main body 30. It should be noted that the manner of adjusting the volume of the speaker 36 is identical to the manner of adjusting the volume of the speaker 16, so the repeated explanation will not be depicted herein again. Similarly, since the speaker 36 is disposed in the rotating member 32, a sound direction D of the speaker 36 will change along with a rotation of the rotating member 32. Accordingly, when the user is located at a specific position with respect to the electronic device 3″, the user may rotate the rotating member 32 to orientate the sound direction D of the speaker 36 to himself/herself, such that the user may receive the sound sent out by the speaker 36 more clearly.

As mentioned in the above, the invention uses the hinge to pivotally connect the rotating member to a side of the main body and disposes the angle sensor at the hinge. When a user rotates the rotating member, the angle sensor senses the angle included between the rotating member and the main body, such that the controller adjusts the volume of the speaker and/or the display function of the display module according to the angle included between the rotating member and the main body. In other words, the user can adjust the volume and/or the display function by rotating the rotating member. Compared to the adjusting manner of the prior art using the button, the knob or the touch panel, the invention can provide creative and innovative operation experience for the user, so as to excite the user to purchase the electronic device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device comprising:
a main body;
a rotating member;
a hinge, the rotating member being pivotally connected to a side of the main body by the hinge, the hinge comprising an angle sensor, the angle sensor sensing an angle included between the rotating member and the main body;
a speaker selectively disposed in one of the main body and the rotating member; and
a controller electrically connected to the speaker and the angle sensor, the controller adjusting a volume of the speaker according to the angle.

2. The electronic device of claim 1, wherein the main body comprises a display module electrically connected to the controller and the controller adjusts a display function of the display module according to the angle.

3. The electronic device of claim 2, wherein the display function comprises at least one of a display range, a display brightness and a display mode.

4. The electronic device of claim 1, wherein the speaker is disposed in the rotating member, such that a sound direction of the speaker changes along with a rotation of the rotating member.

5. An electronic device comprising:
a main body comprising a display module;
a rotating member;
a hinge, the rotating member being pivotally connected to a side of the main body by the hinge, the hinge comprising an angle sensor, the angle sensor sensing an angle included between the rotating member and the main body; and
a controller electrically connected to the display module and the angle sensor, the controller adjusting a display function of the display module according to the angle.

6. The electronic device of claim 5, wherein the display function comprises at least one of a display range, a display brightness and a display mode.

7. The electronic device of claim 5, further comprising a speaker selectively disposed in one of the main body and the rotating member, the controller being electrically connected to the speaker, and the controller adjusts a volume of the speaker according to the angle.

8. The electronic device of claim 7, wherein the speaker is disposed in the rotating member, such that a sound direction of the speaker changes along with a rotation of the rotating member.
